(19) United States
(12) Patent Application Publication
(10) Pub. No.: US 2004/0075038 A1
(43) Pub. Date: Apr. 22, 2004

(54) Miniature ice cube tray for beverage receptacles

(76) Inventor: Vincent Hang, Calgary (CA)

Correspondence Address: STURM & FIX LLP, 206 SIXTH AVENUE, SUITE 1213, DES MOINES, IA, 50309-4076, US

(21) Appl. No.: 10/272,038

(22) Filed: Oct. 16, 2002

(51) Int. Cl. B28B 7/06

(52) U.S. Cl. 249/127

(57) ABSTRACT

An ice cube tray construction (10) for producing cylindrical shaped ice cubes (100) that are dimensioned to pass through the mouth (201) of a beverage receptacle (200) to cool the liquid contents (300) of the receptacle (200); wherein, the tray construction (10) includes an ice cube tray member (20) having an elongated flat rectangular top surface (21) provided with a plurality of circular openings (22) which define the open mouth of a like plurality of cylindrical compartments (23) adapted to produce a plurality of cylindrical ice cubes (100).

### CROSS REFERENCE TO RELATED APPLICATIONS

Not applicable.

### BACKGROUND OF THE INVENTION

1. Field of the Invention

The present invention relates to the field of ice cube tray constructions in general and in particular to an ice cube tray specifically designed to produce cylindrically shaped ice cubes that will fit through the mouth of most conventional beverage receptacles.

2. Description of Related Art

As can be seen by reference to the following U.S. Pat. Nos. Des. 318,281; 5,527,012; 4,783,042; 4,813,646; and, 3,694,235, the prior art is replete with myriad and diverse ice cube tray constructions designed to produce differently configured frozen ice cubes.

While all of the aforementioned prior art constructions are more than adequate for the basic purpose and function for which they have been specifically designed, they are uniformly deficient with respect to their failure to provide a simple, efficient, and practical ice cube tray construction that is specifically designed to produce a plurality of generally cylindrical shaped ice cubes which are dimensioned to be slidably received through the mouths of most conventional beverage receptacles.

Up until the present time, the only way to quickly cool down the internal contents of a beverage receptacle was to try to force shaved ice through the mouth of the receptacle which is not only difficult and time consuming, but also quickly dilutes the contents of the receptacle due to the melt rate of the particles of shaved ice.

As a consequence of the foregoing situation, there has existed a longstanding need among the general public for a new and improved type of ice cube tray construction having a plurality of cylindrical recesses which produce cylindrical ice cubes dimensioned to fit through the mouth of most beverage receptacles; and, the provision of such a construction is the stated objective of the present invention.

### BRIEF SUMMARY OF THE INVENTION

Briefly stated, the ice cube tray construction that forms the basis of the present invention comprises in general an ice cube tray member having a top surface provided with a downwardly depending lip portion and a plurality of downwardly depending open mouthed cylindrical compartments that will produce cylindrical shaped ice cubes that are dimensioned to fit through the mouth of most conventional beverage receptacles to quickly cool the liquid contents of the beverage receptacle.

As will be explained in greater detail further on in the specification, the production of cylindrical ice cubes, the minimum diameter to length ratio of which is approximately 2:1, will assure that a far superior chilling versus dilution ratio will be achieved over shaved ice particles having a very large surface area to volume ratio which results in rapid melting and subsequent dilution of the liquid contents of the beverage receptacle.

Furthermore, the relatively smooth flat top surface of the tray member will facilitate the filling of the individual cylindrical compartments; wherein, a portion of the top surface of the ice cube tray member is devoid of the open mouthed cylindrical compartments thereby forming a handle element for the manipulation of the ice cube tray member.

### BRIEF DESCRIPTION OF THE SEVERAL VIEWS OF THE DRAWINGS

These and other attributes of the invention will become more clear upon a thorough study of the following description of the best mode for carrying out the invention, particularly when reviewed in conjunction with the drawings, wherein:

FIG. 1 is a perspective view of the ice cube tray construction that forms the basis of the present invention;

FIG. 2 is a side elevation view of the ice cube tray construction;

FIG. 3 is a tilted perspective view of the tray construction showing a number of cylindrical ice cubes produced thereby; and,

FIG. 4 is a perspective view in phantom illustrating the intended use of the frozen ice cubes.

### DETAILED DESCRIPTION OF THE INVENTION

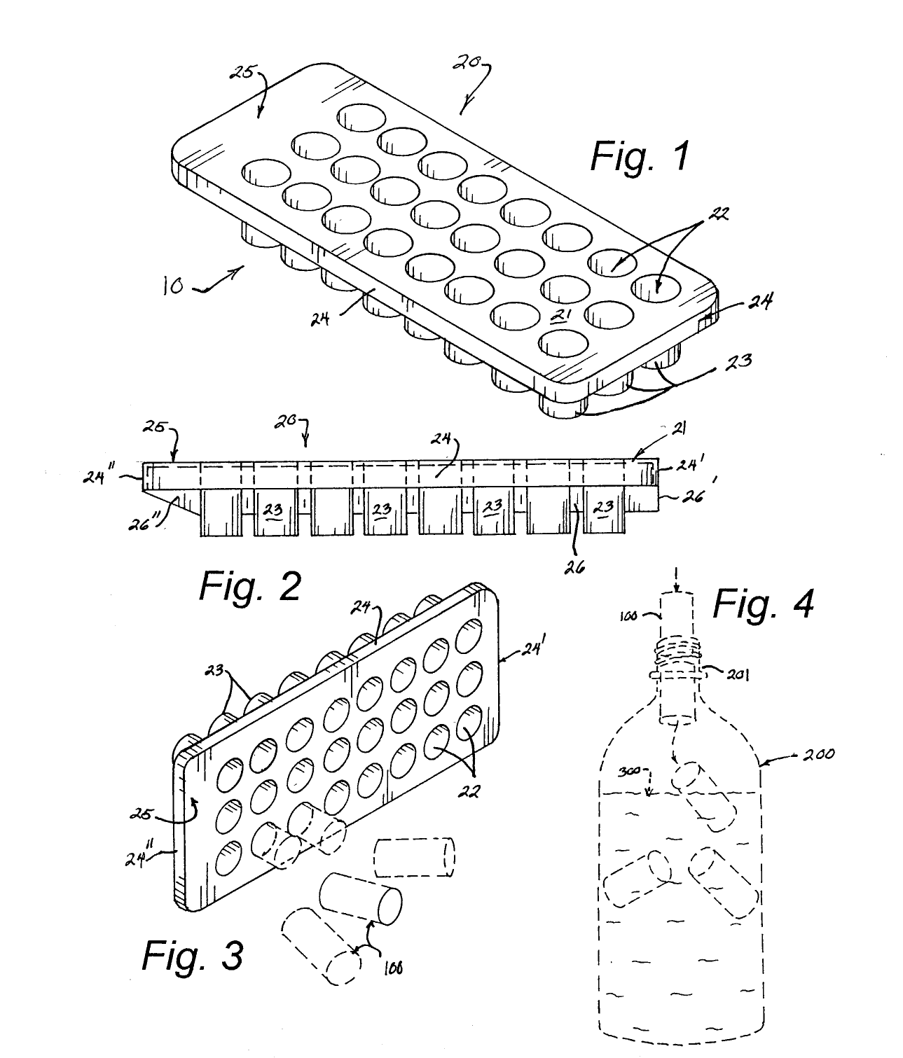

As can be seen by reference to the drawings, and in particular to FIG. 1, the ice cube tray construction that forms the basis of the present invention is designated generally by the reference number 10. The construction 10 in the preferred embodiment of this invention comprises a one-piece molded plastic ice cube tray member 20 having a generally elongated rectangular flat top surface 21 provided with a plurality of circular openings 22 arranged in a plurality of parallel rows; wherein, the circular openings 22 define the mouths of a plurality of cylindrical compartments 23 that depend downwardly from the top surface 21 of the ice cube tray member 20.

In addition, a shown in FIGS. 1 through 3, the top surface 21 of the ice cube tray member 20 has a downwardly depending lip portion 24 that surrounds the array of circular openings 22 and provides rigidity and support to the upper portion of the ice cube tray member 20 in a well recognized fashion.

As can also be appreciated by reference to FIGS. 1 through 3, one end of the top surface 21 of the ice cube tray member is devoid of circular openings 22 and their related cylindrical compartments 23 and this area of the top surface 21 and downwardly depending lip portion 24 forms an outwardly extending handle element 25 for the ice cube tray member 20 without the user's fingers contacting the liquid contained within the cylindrical compartment 23.

Turning now to FIG. 2, it can be also be seen that the bottom of the lip portion 24 of the ice cube tray member 20 is further provided with at least one downwardly depending stiffening rib element 26 disposed between adjacent rows of compartments 23 wherein the distal end 26′ of the rib element 26 descends directly beneath the distal end 24′ of the lip portion 24; and wherein, the proximal end 26″ of the rib element is tapered toward the proximal end 24″ of the lip portion 24 so as not to interfere with the user grasping the handle element 25 of the tray member.

By now it should be appreciated by reference to FIGS. 3 and 4, that the ice cubes 100 produced by the ice cube tray construction 10 are specifically dimensioned to pass through the narrow mouth 201 of a conventional beverage receptacle 200 to cool the liquid contents 300 contained therein; and in the preferred embodiment of the invention, the circumference of the finished ice cubes is approximately 26 mm and the length of each ice cube is 1.5 inches.

Although only an exemplary embodiment of the invention has been described in detail above, those skilled in the art will readily appreciate that many modifications are possible without materially departing from the novel teachings and advantages of this invention. Accordingly, all such modifications are intended to be included within the scope of this invention as defined in the following claims.

Having thereby described the subject matter of the present invention, it should be apparent that many substitutions, modifications, and variations of the invention are possible in light of the above teachings. It is therefore to be understood that the invention as taught and described herein is only to be limited to the extent of the breadth and scope of the appended claims.

I claim:

1. An ice cube tray construction for producing cylindrical shaped ice cubes; wherein, the construction comprises:
an ice cube tray member having a top surface provided with a plurality of circular openings defining the open mouth of a like plurality of cylindrical compartments which depend downwardly from said top surface.

2. The construction as in claim 1; wherein, the top surface has a generally flat elongated rectangular configuration.

3. The construction as in claim 1; wherein, said plurality of circular openings are arranged in a plurality of parallel rows of circular openings.

4. The construction as in claim 2; wherein, said plurality of circular openings are arranged in a plurality of parallel rows of circular openings.

5. The construction as in claim 1; wherein, the top surface is further provided with a downwardly depending lip portion.

6. The construction as in claim 2; wherein, the top surface is further provided with a downwardly depending lip portion.

7. The construction as in claim 3; wherein, the top surface is further provided with a downwardly depending lip portion.

8. The construction as in claim 4; wherein, the top surface is further provided with a downwardly depending lip portion.

9. The construction as in claim 1; wherein, the top surface of the tray construction has a distal end and a proximal end wherein the proximal end is devoid of circular openings.

10. The construction as in claim 2; wherein, the top surface of the tray construction has a distal end and a proximal end wherein the proximal end is devoid of circular openings.

11. The construction as in claim 3; wherein, the top surface of the tray construction has a distal end and a proximal end wherein the proximal end is devoid of circular openings.

12. The construction as in claim 4; wherein, the top surface of the tray construction has a distal end and a proximal end wherein the proximal end is devoid of circular openings.

13. The construction as in claim 5; wherein, the top surface of the tray construction has a distal end and a proximal end wherein the proximal end is devoid of circular openings.

14. The construction as in claim 5; further including at least one stiffening rib element that depends downwardly from the lip portion of the ice cube tray member.

15. The construction as in claim 6; further including at least one stiffening rib element that depends downwardly from the lip portion of the ice cube tray member.

16. The construction as in claim 7; further including at least one stiffening rib element that depends downwardly from the lip portion of the ice cube tray member.

17. The construction as in claim 8; further including at least one stiffening rib element that depends downwardly from the lip portion of the ice cube tray member.

18. The construction as in claim 9; further including at least one stiffening rib element that depends downwardly from the lip portion of the ice cube tray member.
